(19) United States
(12) Patent Application Publication
(10) Pub. No.: US 2009/0088879 A1
(43) Pub. Date: Apr. 2, 2009

(54) AUDIO REPRODUCTION DEVICE AND METHOD FOR AUDIO REPRODUCTION

(75) Inventors: Kazuyuki OKANO, Ome-shi (JP); Takanobu MUKAIDE, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/208,739

(22) Filed: Sep. 11, 2008

(30) Foreign Application Priority Data
Sep. 28, 2007 (JP) 2007-255737

(51) Int. Cl. G06F 17/00

(52) U.S. Cl. 700/94

(57) ABSTRACT

According to one embodiment, the invention provides an audio reproduction device including a generation module which generates selection information used for dividing input audio information into an audio channel which can be reproduced by a first audio reproduction device and an audio channel which cannot be reproduced by the first audio reproduction device, and a division module which separates an audio channel, which cannot be reproduced by the first audio reproduction device, from the input audio information, on the basis of the selection information generated by the generation module, and outputs the audio information, acquired by the separation, to an external second audio reproduction device to reproduce the audio information.

### CROSS-REFERENCE TO RELATED APPLICATIONS

This application is based upon and claims the benefit of priority from Japanese Patent Application No. 2007-255737, filed Sep. 28, 2007, the entire contents of which are incorporated herein by reference.

### BACKGROUND

1. Field

One embodiment of the invention relates to an audio reproduction device, which performs audio reproduction corresponding to multiple channels of 5.1 or more channels for example, and a method for audio reproduction.

2. Description of the Related Art

As is well known, recently, an optical disk such as DVD (digital versatile disk) is widely used as a digital recording medium. Presently, a Hi-Vision-compliant next-generation DVD format, which can realize recording with a higher density than DVD, so-called HD-DVD (high definition DVD), is completed.

For this type of next-generation optical disk, there has been developed a new format for audio recording, which includes DTS-HD (digital theater system high definition), Dolby true HD, and the like. In this new format, the number of channels by which audio is reproduced can be freely set by a content creator.

Meanwhile, as an audio reproduction system used in an existing general home theater system, the audio reproducing system performing audio reproduction of 5.1 channels is mostly used. Therefore, when more than 5.1 audio channels are required to be reproduced, the requirement cannot be properly met, and therefore, the audio reproduction intended by a content creator cannot be realized.

Jpn. Pat. Appln. KOKAI Publication No. 2004-236192 discloses that a home server manages the number of audio channels which can be respectively reproduced by plural sound apparatuses connected to the home server, and the sound apparatuses used for audio reproduction are combined with each other in response to the position of a user and the number of channels used for audio reproduction, whereby the audio reproduction corresponding to multiple channels is performed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the invention and the outline of an audio reproduction system;

FIG. 2 is a block diagram for explaining a signal processing system in an optical disk reproduction device constituting the audio reproduction system in the same example;

FIG. 3 is a block diagram for explaining a signal processing system in an audio reproducing apparatus constituting the audio reproduction system in the same example;

FIG. 4 is a flowchart for explaining a part of the processing operation in the optical disk reproduction device constituting the audio reproduction system in the same example;

FIG. 5 is a flowchart for explaining the remaining parts of the processing operation in the optical disk reproduction device constituting the audio reproduction system in the same example;

FIGS. 6A and 6B are views for explaining an example of channel information acquired by the optical disk reproduction device constituting the audio reproduction system in the same example;

FIG. 7 is a view for explaining an example of channel selection information generated by the optical disk reproduction device constituting the audio reproduction system in the same example;

FIG. 8 is a flowchart for explaining a main part of the processing operation in the optical disk reproduction device constituting the audio reproduction system in the same example;

FIG. 9 is a flowchart for explaining the processing operation in the audio reproducing apparatus constituting the audio reproduction system in the same example;

FIG. 10 is a block diagram for explaining a modification of the optical disk reproduction device constituting the audio reproduction system in the same example;

FIG. 11 is a block diagram for explaining a modification of the audio reproducing apparatus constituting the audio reproduction system in the same example;

FIG. 12 is a flowchart for explaining a part of the processing operation in the optical disk reproduction device in the same modification;

FIG. 13 is a flowchart for explaining the remaining parts of the processing operation in the optical disk reproduction device in the same modification;

FIG. 14 is a flowchart for explaining the main part of the processing operation in the optical disk reproduction device in the same modification;

FIG. 15 is a flowchart for explaining the processing operation in the audio reproducing apparatus in the same modification; and

FIG. 16 is a view for explaining an example of an updating menu screen displayed in the optical disk reproduction device in the same example.

### DETAILED DESCRIPTION

Various embodiments according to the invention will be described hereinafter with reference to the accompanying drawings. In general, according to one embodiment of the invention, the invention provides an audio reproduction device including a generation module which generates selection information used for dividing input audio information into an audio channel which can be reproduced by a first audio reproduction device and an audio channel which cannot be reproduced by the first audio reproduction device, and a division module which separates an audio channel, which cannot be reproduced by the first audio reproduction device, from the input audio information, on the basis of the selection information generated by the generation module, and outputs the audio information, acquired by the separation, to an external second audio reproduction device to reproduce the audio information.

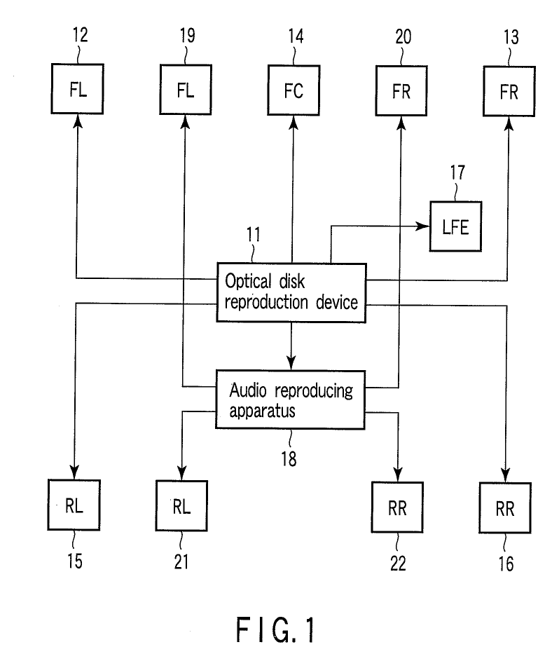

Hereinafter, an example of the invention is described in detail with reference to the drawings. FIG. 1 shows the outline of an audio reproduction system explained in this example. In FIG. 1, a reference numeral 11 is an optical disk reproduction device for reproducing an optical disk such as HD-DVD. The optical disk reproduction device 11 has a function of performing audio reproduction corresponding to 5.1 channels.

In other words, a front left speaker 12, a front right speaker 13, a front center speaker 14, a rear left speaker 15, a rear right speaker 16, and a low frequency effect speaker 17 are respectively connected to the optical disk reproduction device 11.

Regarding audio signals acquired by the reproduction of an optical disk, the optical disk reproduction device 11 supplies the audio signals of a front left channel, a front right channel, a front center channel, a rear left channel, a rear right channel, and a low frequency effect channel to the above speakers 12 to 17 respectively corresponding to the audio signals of these channels, and reproduces the audio signals through the speakers 12 to 17, whereby the audio reproduction corresponding to 5.1 channels can be realized.

Further, the optical disk reproduction device 11 is connected with an audio reproducing apparatus 18. When the number of channels of the audio signals acquired by the reproduction of the optical disk is larger than 5.1 channels, the optical disk reproduction device 11 outputs the audio signals of the extra channels, which cannot be reproduced in the optical disk reproduction device 11, to the audio reproducing apparatus 18 to make the audio reproducing apparatus 18 reproduce the audio signals.

In other words, a front left speaker 19, a front right speaker 20, a rear left speaker 21, a rear right speaker 22 are connected to the audio reproducing apparatus 18. Regarding audio signals supplied from the optical disk reproduction device 11, the audio reproducing apparatus 18 supplies the audio signals of a front left center channel, a front right center channel, a rear left center channel, and a rear right center channel to the speakers 19 to 22 respectively corresponding to the audio signals of these signals, and reproduces the audio signals through the speakers 19 to 22, whereby it is possible to realize the audio reproduction corresponding to 9.1 channels in total, including the channels reproduced in the optical disk reproduction device 11.

According to the above example, the audio signals of channels more than the number of channels which can be reproduced in the optical disk reproduction device 11, that is, the audio signals corresponding to the extra channels which cannot be reproduced in the optical disk reproduction device 11 are distributed to the audio reproducing apparatus 18, and, thus, to be reproduced in the audio reproducing apparatus 18. Therefore, the audio reproduction corresponding to multiple channels of, for example, 5.1 or more channels can be easily realized, and, thus, the audio reproduction corresponding to the intent of a content creator can be realized.

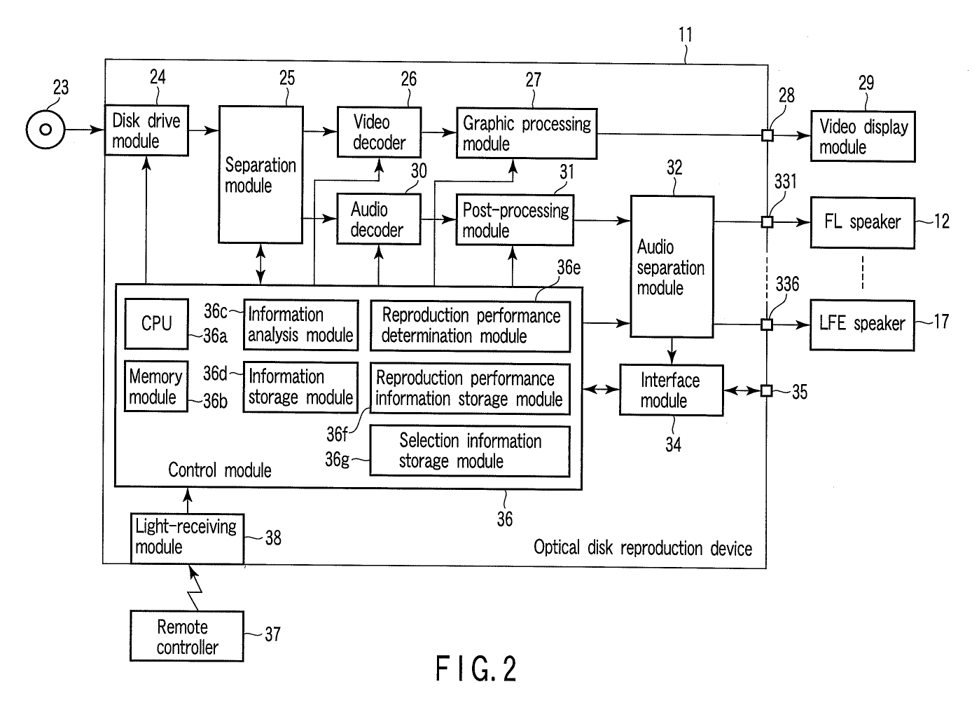

FIG. 2 shows a signal processing system in the optical disk reproduction device 11. In other words, the optical disk reproduction device 11 has a disk drive module 24 which has an optical disk 23 mounted therein and reads data recorded in the optical disk 23. The data read by the disk drive module 24 is supplied to a separation module 25 to be separated into video data and audio data.

The video data acquired by the separation in the separation module 25 is supplied to a video decoder 26 to be subjected to a decoding processing and then to be supplied to a graphic processing module 27. A predetermined OSD (on screen display) signal is superimposed on the video data, and thereafter, the video data is supplied to an external video display module 29 through an output terminal 28 to be displayed in the external video display module 29.

In addition, the audio data acquired by the separation in the separation module 25 is supplied to an audio decoder 30, and, thus, to be subjected to a decoding processing. The audio data is then supplied to a post-processing module 31, and, thus, to be subjected to a post processing such as down mixing. Thereafter, the audio data is supplied to an audio division module 32. The audio division module 32 separates the input audio signal into the audio signals of 5.1 channels which can be reproduced in the optical disk reproduction device 11 and the audio signals corresponding to the extra channels more than 5.1 channels.

The audio signals of 5.1 channels acquired by the division in the audio division module 32 are respectively supplied to the corresponding speakers 12 to 17 through output terminals 331 to 336, and, thus, to be reproduced. Meanwhile, the audio signals of the extra channels acquired by the division in the audio division module 32 are supplied to an interface module 34 to be converted into a format based on a standard such as the HDMI (high definition multimedia interface) standard, and thereafter to be supplied to the audio reproducing apparatus 18 through an input/output terminal 35.

Here, a control module 36 controls the overall operation of the optical disk reproduction device 11 including the above reproduction operation. The control module 36 has a built-in CPU (central processing unit) 36a and receives operation information, transmitted from a remote controller 37 and received by a light-receiving module 38, to control each module so that the operation contents are reflected.

In this case, the control module 36 mainly utilizes a memory module 36a. The memory module 36b has a ROM (read only memory) in which a control program is executed by the CPU 36a is stored, a RAM (random access memory) providing a work area for the CPU 36a, and a nonvolatile memory in which various pieces of setting information, various pieces of control information, and the like are stored.

The control module 36 further has an information analysis module 36c which analyzes the audio data acquired by the separation in the separation module 25 to acquire channel information. The information analysis module 36c analyzes attribute information such as the number of channels included in the audio data and the types of audio signals corresponding to any of the channels. The control module 36 has an information storage module 36d for storing the channel information acquired in the information analysis module 36c.

The control module 36 still further has a reproduction performance determination module 36e. The reproduction performance determination module 36e communicates with the audio reproducing apparatus 18 through the interface module 34 to acquire information showing the audio reproduction performance of the audio reproducing apparatus 18. This audio reproduction performance information includes information showing the number of channels which can be reproduced, the types of the channels, and the like.

The reproduction performance determination module 36e determines the audio signals to be respectively reproduced by the speakers 12 to 17 of the optical disk reproduction device 11 and the speakers 19 to 22 of the audio reproducing apparatus 18, on the basis of the audio reproduction performance information in the audio reproducing apparatus 18, the audio reproduction performance information in the optical disk reproduction device 11, and the channel information stored in the information storage module 36d. Thereafter, the audio division module 32 is controlled based on the determination result in the reproduction performance determination module 36e.

The control module 36 stores the audio reproduction performance information in the audio reproducing apparatus 18 acquired by the reproduction performance determination module 36e, and, at the same time, has a reproduction performance information storage module 36f for storing the reproduction performance information in the optical disk reproduction device 11 itself. The control module 36 further has a selection information storage module 36g for storing the channel selection information as the determination result in the reproduction performance determination module 36e.

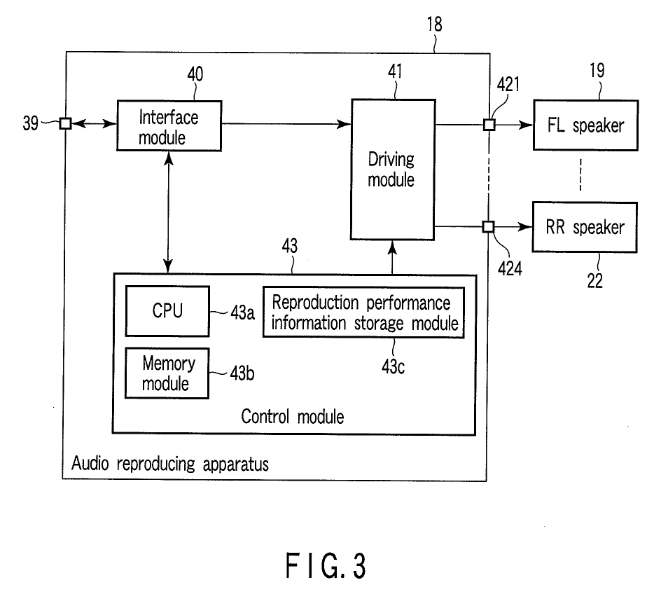

FIG. 3 shows a signal processing system of the audio reproducing apparatus 18. In other words, the audio reproducing apparatus 18 has an input/output terminal 39 connected to the input/output terminal 35 of the optical disk reproduction device 11. According to this constitution, each audio signal of the extra channels output from the optical disk reproduction device 11 is supplied to the input/output terminal 39 of the audio reproducing apparatus 18. Each audio signal supplied to the input/output terminal 39 is supplied to a driving module 41 through an interface module 40, and thereafter to be supplied to the corresponding speakers 19 to 22 through the output terminals 421 to 424, and, thus, to be reproduced.

A control module 43 controls the overall operation of the audio reproducing apparatus 18 including the above reproduction operation. The control module 43 has a built-in CPU 43a and receives operation information supplied from the optical disk reproduction device 11 to control each module so that the operation contents are reflected.

In this case, the control module 43 mainly utilizes a memory module 43b. The memory module 43b has a ROM in which a control program executed by the CPU 43a is stored, a RAM providing a work area for the CPU 43a, and a nonvolatile memory in which various pieces of setting information, various pieces of control information, and the like are stored.

Further, the control module 43 has a reproduction performance information storage module 43c for storing the reproduction performance information in the audio reproducing apparatus 18 itself. The control module 43 is operated to output reproduction performance information, stored in the reproduction performance information storage module 43c, from the interface module 40 to the optical disk reproduction device 11 through the input/output terminal 39, in response to the request from the optical disk reproduction device 11.

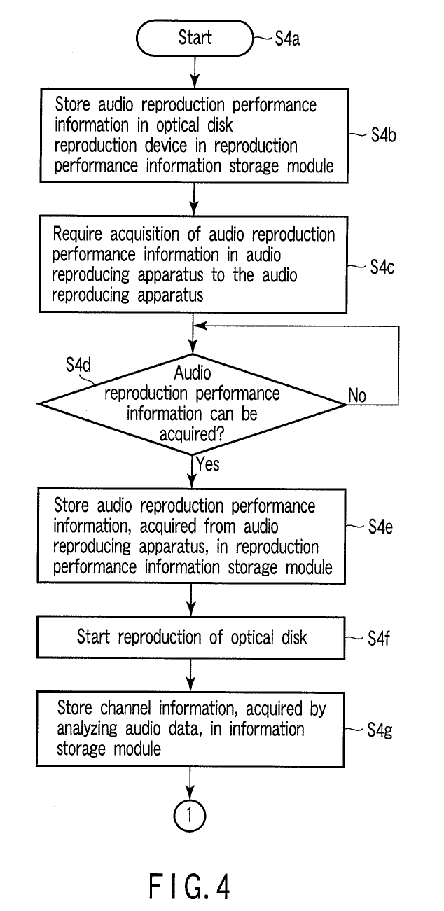

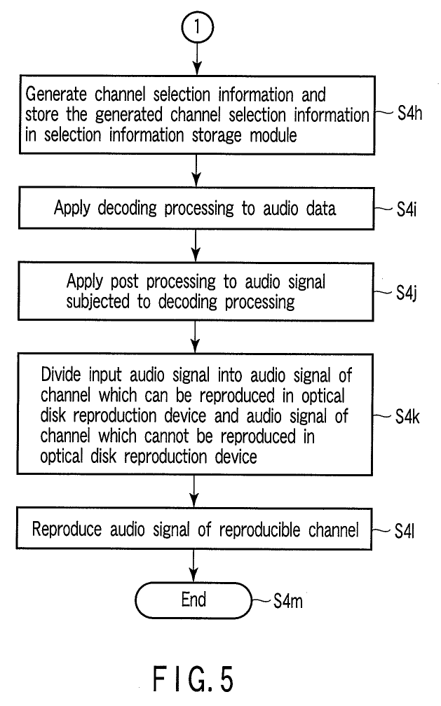

The operation of the audio reproduction system having the above constitution is described below. FIGS. 4 and 5 are flowcharts showing the main processing operation in the optical disk reproduction device 11. When the processing is started (step S4a), the audio reproduction performance information in the optical disk reproduction device 11 is recorded in the reproduction performance information storage module 36f (step S4b). In such a state, the control module 36 obtains, from the audio reproducing apparatus 18, the requirement, of the audio reproducing apparatus 18, for acquisition of audio reproduction performance information, including the number of reproducible audio channels (step S4c).

When the control module 36 determines that the audio reproduction performance information is acquired from the audio reproducing apparatus 18 (step S4d is “Yes”), the audio reproduction performance information acquired from the audio reproducing apparatus 18 is stored in the reproduction performance information storage module 36f (step S4e).

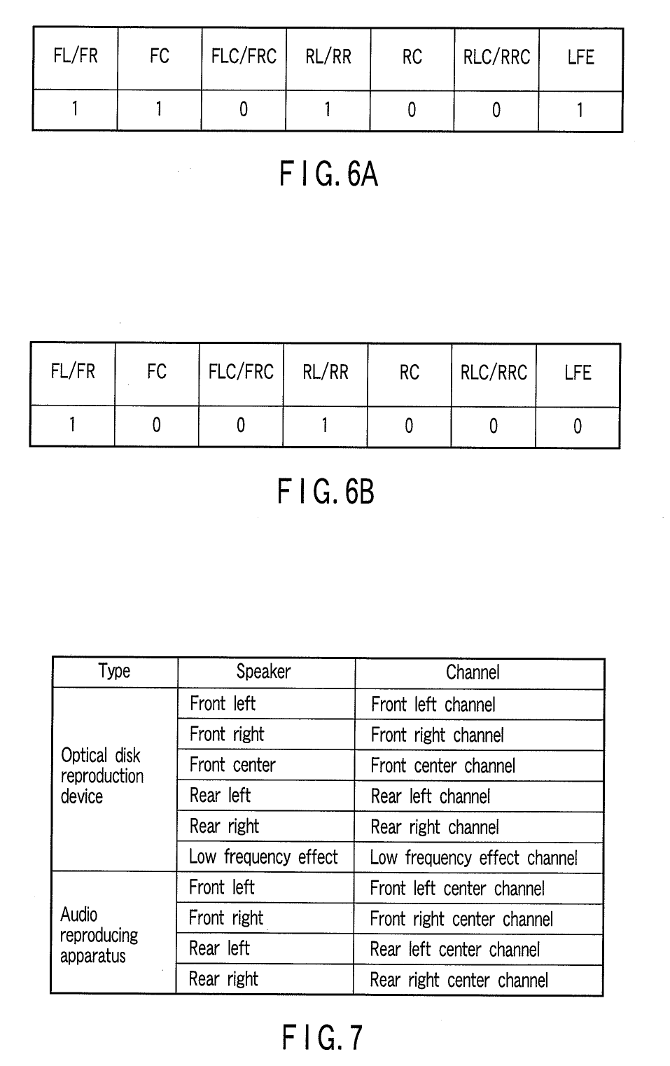

In this case, the audio reproduction performance information in the optical disk reproduction device 11 stored in the reproduction performance information storage module 36f shows the number of channels which can be reproduced by the connected speakers 12 to 17 and the types of the channels, for example, as shown in FIG. 6A, for example. In other words, the front left speaker 12, the front right speaker 13, the front center speaker 14, the rear left speaker 15, the rear right speaker 16, and the low frequency effect speaker 17 are connected to the optical disk reproduction device 11.

The audio reproduction performance information in the audio reproducing apparatus 18 stored in the reproduction performance information storage module 36f also shows the number of channels which can be reproduced by the connected speakers 19 to 22 and the types of the channels, as shown in FIG. 6B, for example. In other words, the front left speaker 19, the front right speaker 20, the rear left speaker 21, and the rear right speaker 22 are connected to the audio reproducing apparatus 18.

Thereafter, the control module 36 starts the reproduction of the optical disk 23 (step S4f), and makes the information analysis module 36c analyze the audio data acquired from the optical disk 23, and, thus, to acquire the channel information, whereby the channel information is stored in the information storage module 36d (step S4g). In this case, as the channel information, the number of channels in the audio data is 9.1 channels. As the types of the channels, there are audio signals of a front left channel, a front right channel, a front center channel, a rear left channel, a rear right channel, a low frequency effect channel, a front left center channel, a front right center channel, a rear left center channel, and a rear right center channel.

Next, in step S4h, the control module 36 makes the reproduction performance determination module 36e determine the audio signals to be reproduced by the speakers 12 to 17 of the optical disk reproduction device 11 and the speakers 19 to 22 of the audio reproducing apparatus 18, and then to store the channel selection information, which is the determination result in the reproduction performance determination module 36e, in the selection information storage module 36g.

In this case, the reproduction performance determination module 36e determines the channels of the audio signals to be respectively reproduced by the speakers 12 to 17 and 19 to 22, on the basis of the audio reproduction performance information in the audio reproducing apparatus 18 and the audio reproduction performance information in the optical disk reproduction device 11, stored in the reproduction performance information storage module 36f, and the channel information stored in the channel information storage module 36d.

In other words, regarding the channel selection information stored in the selection information storage module 36g, with regard to the channel selection information in the optical disk reproduction device 11, as shown in, for example, FIG. 7, the audio signals of the front left channel, the front right channel, the front center channel, the rear left channel, the rear right channel, the low frequency effect channel are respectively corresponded to the front left speaker 12, the front right speaker 13, the front center speaker 14, the rear left speaker 15, the rear right speaker 16, and the low frequency effect speaker 17.

With regard to the channel selection information in the audio reproducing apparatus 18, the respective audio signals of the front left center channel, the front right center channel, the rear left center channel, and the rear right center channel are corresponded to the front left speaker 19, the front right speaker 20, the rear left speaker 21, and the rear right speaker 22.

The control module 36 makes the audio decoder 30 apply the decoding processing to the audio data on the basis of the channel selection information in step S4i and makes the post-processing module 31 apply the post processing to the audio signal subjected to the decoding processing in step S4j.

Thereafter, in step S4k, the control module 36 separates the audio signals into an audio signal of a channel which can be reproduced in the optical disk reproduction device 11 and an audio signal of a channel which cannot be reproduced in the optical disk reproduction device 11 with the aid of the audio division module 32 and outputs the audio signal of the channel which cannot be reproduced in the optical disk reproduction device 11 to the audio reproducing apparatus 18. In this case, the audio division module 32 divides the audio signal of each channel with reference to the channel selection information stored in the selection information storage module 36g.

For instance, the channel selection information shows that the audio signal of the front left channel is reproduced by the front left speaker 12 of the optical disk reproduction device 11, whereby it is determined that the audio signal can be reproduced in the optical disk reproduction device 11. Meanwhile, the channel selection information shows that the audio signal of the front left center channel is reproduced by the front left speaker 19 of the audio reproducing apparatus 18, whereby it is determined that the audio signal cannot be reproduced in the optical disk reproduction device 11.

The control module 36 supplies the respective audio signals, which have been determined by the audio division module 32 to be capable of being reproduced in the optical disk reproduction device 11, to the corresponding speakers 12 to 17 through the output terminals 331 to 336, and, thus, to perform the audio reproduction in step S4l, whereby the processing is terminated (step S4m).

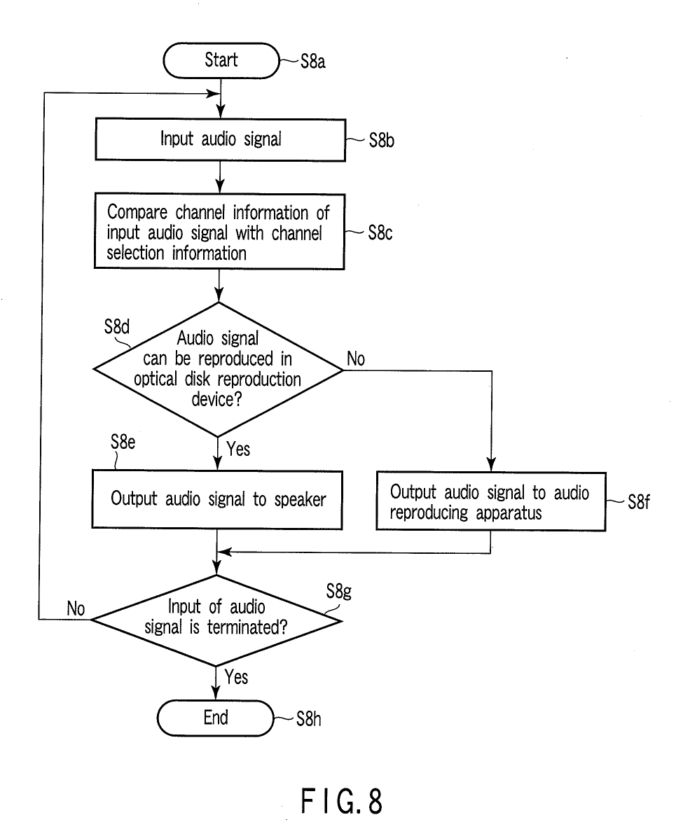

FIG. 8 is a flowchart showing the determination processing operation in step S4k. When the processing is started (step S8a), the audio division module 32 inputs the audio signal from the post-processing module 31 in step S8b, compares the channel information acquired from the input audio signal and the channel selection information stored in the selection information storage module 36g in step S8c, and discriminates the audio signal of the channel which can be reproduced in the optical disk reproduction device 11 in step S8d.

The audio signals of the channels determined to be capable of being reproduced in the optical disk reproduction device 11 (step S8d is “Yes”) are output to the speakers 12 to 17 by the audio division module 32 in step S8e. Meanwhile, the audio signal of the channel determined to be non-reproducible in the optical disk reproduction device 11 (step S8d is “No”) is output to the audio reproducing apparatus 18 by the audio division module 32 in step S8f.

After step S8e or S8f, the audio division module 32 determines whether or not the input of the audio signal is terminated in step S8g. When it is determined that the input of the audio signal is not terminated (step S8g is “No”), the processing is returned to step S8b. When it is determined that the input of the audio signal is terminated (step S8g is “Yes”), the processing is terminated (step S8h).

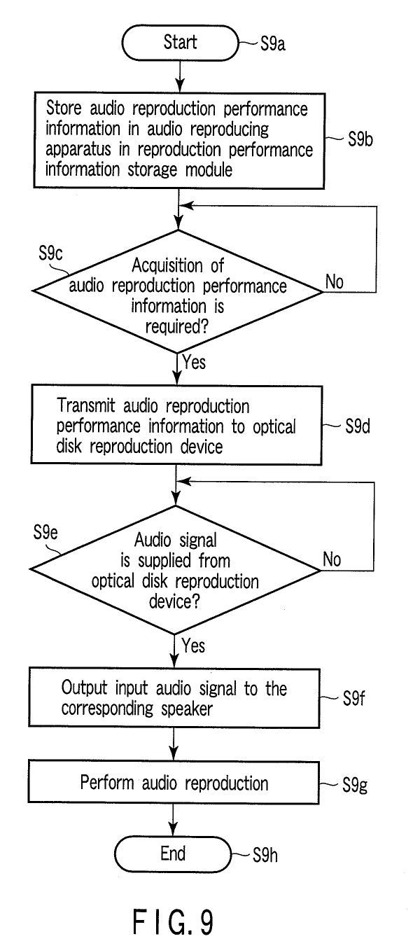

FIG. 9 is a flowchart summarizing the main processing operation in the audio reproducing apparatus 18. When the processing is started (step S9a), the audio reproduction performance information in the audio reproducing apparatus 18 is recorded in the reproduction performance information storage module 43c in step S9b. In such a state, the control module 43 determines whether or not the acquisition of the audio reproduction performance information is required by the optical disk reproduction device 11 (step S9c). When the acquisition is required (step S9c is “Yes”), the audio reproduction performance information stored in the reproduction performance information storage module 43c is transmitted to the optical disk reproduction device 11 in step S9d.

Thereafter, the control module 43 determines whether or not the audio signal of the channel, which cannot be reproduced in the optical disk reproduction device 11, is supplied from the optical disk reproduction device 11 in step S9e. When step S9e is “Yes”, the input audio signals are respectively output to the corresponding speakers 19 to 22 through output terminals 421 to 424 in step S9f to perform the audio reproduction in step S9g, whereby the processing is terminated (step S9h).

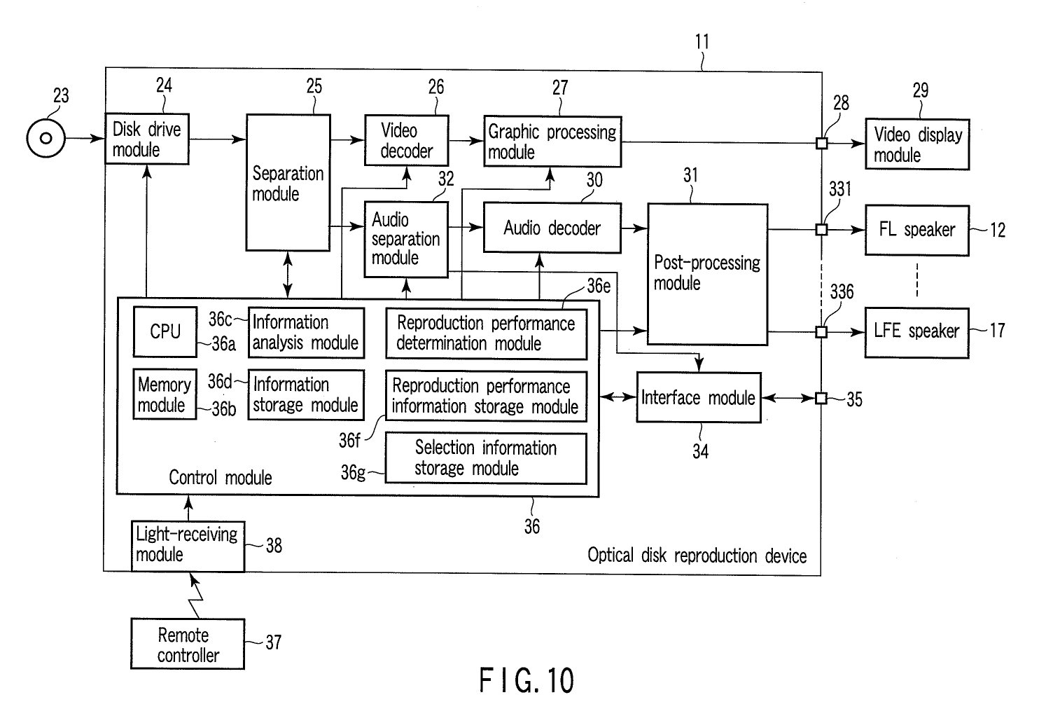

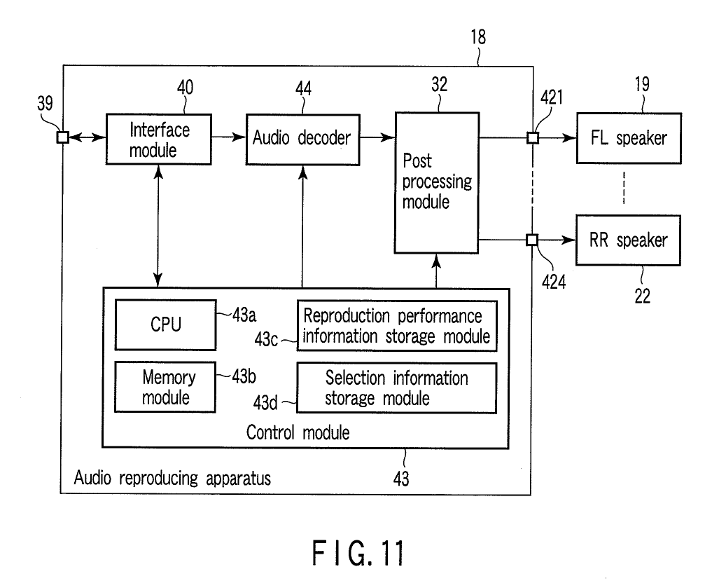

Next, a modification of the above example is described. FIG. 10 shows a modification of the signal processing system of the optical disk reproduction device 11. In FIG. 10, the same components as those in FIG. 2 are assigned the same reference numerals. The audio data acquired by the separation in the separation module 25 is supplied to the audio division module 32 to be separated into audio data of 5.1 channels which can be reproduced in the optical disk reproduction device 11 and the audio data corresponding to the extra channels more than 5.1 channels.

The audio data of 5.1 channels, which can be reproduced in the optical disk reproduction device 11, are supplied to the audio decoder 30 to be subjected to a decoding processing and then a post-processing module 31, and, thus, subjected to a post processing such as down mixing. Thereafter, the audio data are respectively supplied to the corresponding speakers 12 to 17 through the output terminals 331 to 336 to be reproduced.

The undecoded audio data corresponding to the extra channels more than the number of channels which can be reproduced in the optical disk reproduction device 11 are supplied to the interface module 34 to be converted into a format based on, for example, the HDMI standard, and thereafter to be supplied to the audio reproducing apparatus 18 through the input/output terminal 35 to be reproduced.

Further, the channel selection information generated in the reproduction performance determination module 36e is also supplied to the audio reproducing apparatus 18 through the interface module 34 and the input/output terminal 35.

FIG. 11 shows the signal processing system of the audio reproducing apparatus 18 connected to the optical disk reproduction device 11 shown in FIG. 10. In FIG. 11, the same components as those in FIG. 3 are assigned the same reference numerals. The audio data of the extra channels output from the optical disk reproduction device 11 are supplied to an audio decoder 44 through the input/output terminal 39 and the interface module 40 to be subjected to a decoding processing. The decoded audio data are supplied to a post-processing module 45 to be subjected to a post processing such as down mixing, and thereafter respectively supplied to the corresponding speakers 19 to 22 through the output terminals 421 to 424 to be reproduced Further, the control module 43 has a selection information storage module 43d for storing the channel selection information output from the optical disk reproduction device 11.

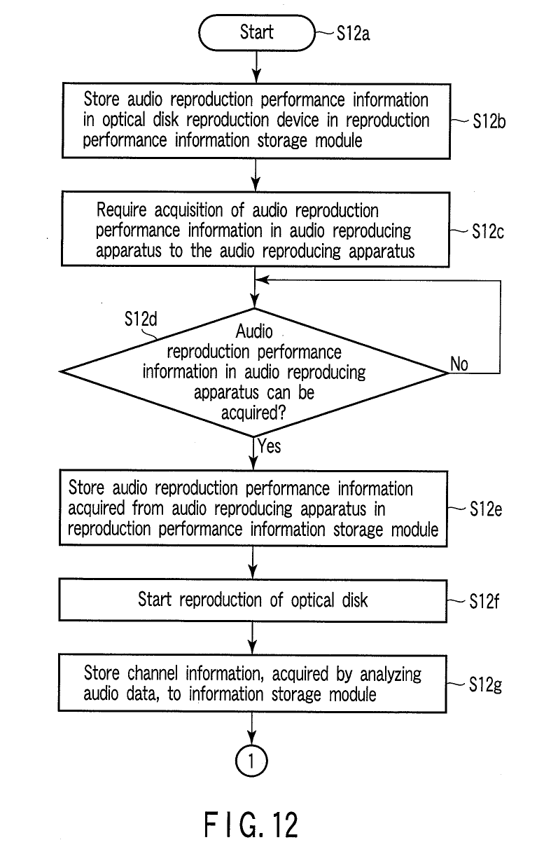

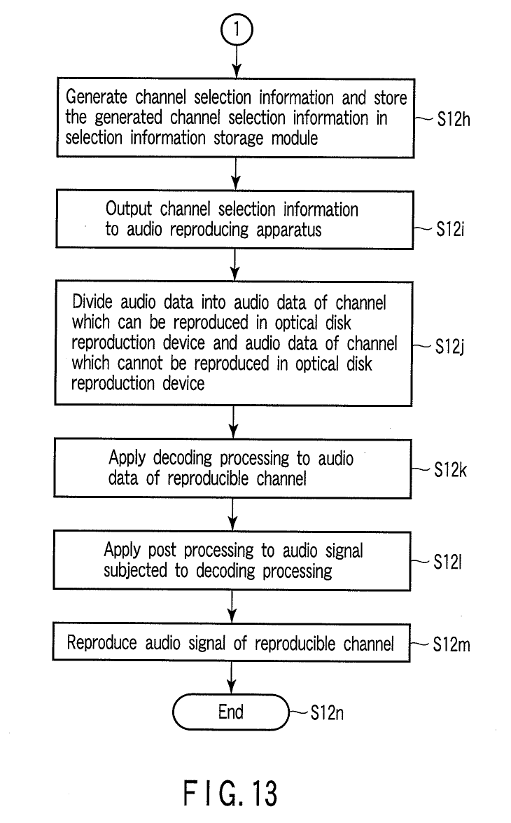

FIGS. 12 and 13 are flowcharts showing the main processing operation in the optical disk reproduction device 11 shown in FIG. 10. In other words, when the processing is started (step S12a), the audio reproduction performance information in the optical disk reproduction device 11 is recorded in the reproduction performance information storage module 36f in step S12b. In such a state, the control module 36 requires the acquisition of the audio reproduction performance information in the audio reproducing apparatus 18 to the audio reproducing apparatus 18 in step S12c.

When the control module 36 determines that the audio reproduction performance information is acquired from the audio reproducing apparatus 18 (step S12d is “Yes”), the audio reproduction performance information acquired from the audio reproducing apparatus 18 is stored in the reproduction performance information storage module 36f in step S12e.

In this case, the audio reproduction performance information in the optical disk reproduction device 11 stored in the reproduction performance information storage module 36f shows the number of channels which can be respectively reproduced by the connected speakers 12 to 17 and the types of the channels, as shown in FIG. 6A. In other words, the front left speaker 12, the front right speaker 13, the front center speaker 14, the rear left speaker 15, the, rear right speaker 16, and the low frequency effect speaker 17 are respectively connected to the optical disk reproduction device 11.

The audio reproduction performance information in the audio reproducing apparatus 18 stored in the reproduction performance information storage module 36f also shows the number of channels which can be respectively reproduced by the connected speakers 19 to 22 and the types of the channels, as shown in FIG. 6B. In other words, the front left speaker 19, the front right speaker 20, the rear left speaker 21, and the rear right speaker 22 are connected to the audio reproducing apparatus 18.

Thereafter, the control module 36 starts the reproduction of the optical disk 23 in step S12f, makes the information analysis module 36c analyze the audio data acquired from the optical disk 23, and, thus, to acquire the channel information, whereby the channel information is stored in the information storage module 36d (step S12g). In this case, as the channel information, the number of channels in the audio data is 9.1 channels. As the types of the channels, there are audio signals of a front left channel, a front right channel, a front center channel, a rear left channel, a rear right channel, a low frequency effect channel, a front left center channel, a front right center channel, a rear left center channel, and a rear right center channel.

Next, in step S12h, the control module 36 makes the reproduction performance determination module 36e determine the audio signals of the channels to be respectively reproduced by the speakers 12 to 17 of the optical disk reproduction device 11 and the speakers 19 to 22 of the audio reproducing apparatus 18, and then to store the channel selection information, which is the determination result in the reproduction performance determination module 36e, in the selection information storage module 36g.

In this case, the reproduction performance determination module 36e determines channels of the audio signals to be respectively reproduced by the speakers 12 to 17 and 19 to 22, on the basis of the audio reproduction performance information in the audio reproducing apparatus 18 and the audio reproduction performance information in the optical disk reproduction device 11, stored in the reproduction performance information storage module 36f, and the channel information stored in the channel information storage module 36d.

In other words, regarding the channel selection information stored in the selection information storage module 36g, with regard to the channel selection information in the optical disk reproduction device 11, as shown in FIG. 7, the respective audio signals of the front left channel, the front right channel, the front center channel, the rear left channel, the rear right channel, the low frequency effect channel are respectively corresponded to the front left speaker 12, the front right speaker 13, the front center speaker 14, the rear left speaker 15, the rear right speaker 16, and the low frequency effect speaker 17.

With regard to the channel selection information in the audio reproducing apparatus 18, the respective audio signals of the front left center channel, the front right center channel, the rear left center channel, and the rear right center channel are respectively corresponded to the front left speaker 19, the front right speaker 20, the rear left speaker 21, and the rear right speaker 22.

Thereafter, in step S12i, the control module 36 outputs the channel selection information, generated by the reproduction performance determination module 36e, to the audio reproducing apparatus 18.

Subsequently, in step S12j, the control module 36 separates the audio data into audio data of a channel which can be reproduced in the optical disk reproduction device 11 and audio data of a channel which cannot be reproduced in the optical disk reproduction device 11 with the aid of the audio division module 32 and outputs the audio data of the channel, which cannot be reproduced in the optical disk reproduction device 11, to the audio reproducing apparatus 18. In this case, the audio division module 32 divides the audio signal of each channel with reference to the channel selection information stored in the selection information storage module 36g.

For instance, the channel selection information shows that the audio signal of the front left channel is reproduced by the front left speaker 12 of the optical disk reproduction device 11, whereby it is determined that the audio signal can be reproduced in the optical disk reproduction device 11. Meanwhile, the channel selection information shows that the audio signal of the front left center channel is reproduced by the front left speaker 19 of the audio reproducing apparatus 18, whereby it is determined that the audio signal cannot be reproduced in the optical disk reproduction device 11.

Subsequently, the control module 36 makes the audio decoder 30 apply a decoding processing to the audio data of the channel, which has been determined to be capable of being reproduced in the optical disk reproduction device 11, on the basis of the channel selection information in step S12k and makes the post-processing module 31 apply the post processing to the audio signal subjected to the decoding processing in step S12l.

Thereafter, the control module 36 supplies the respective decoded audio signals of the channels, which have been determined to be capable of being reproduced in the optical disk reproduction device 11, to the corresponding speakers 12 to 17 through the output terminals 331 to 336, and, thus, to perform the audio reproduction in step S12m, whereby the processing is terminated (step S12n).

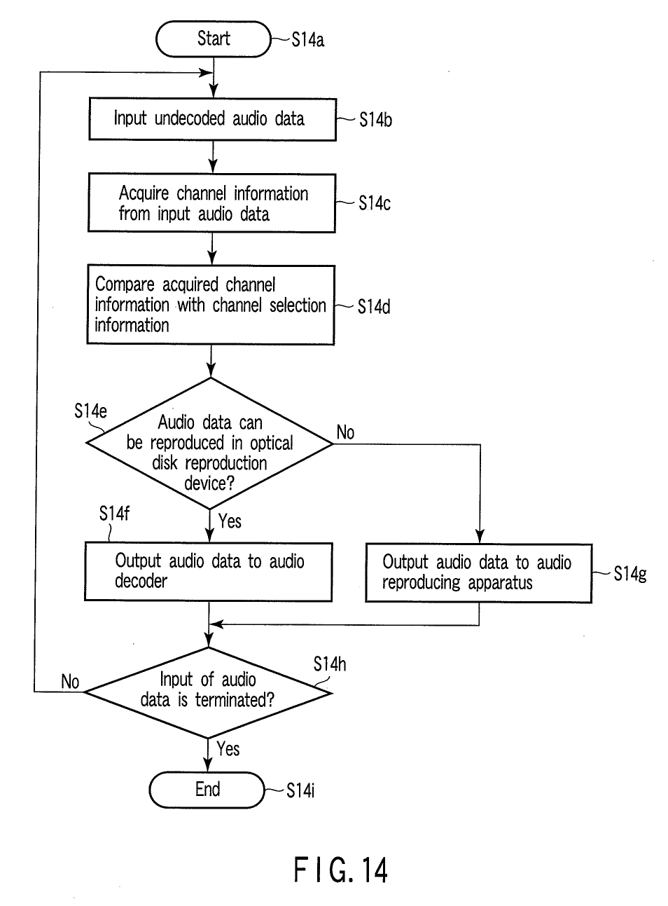

FIG. 14 is a flowchart summarizing the determination processing operation in step S12j. When the processing is started (step S14a), the audio division module 32 inputs the undecoded audio data acquired by the separation in the separation module 25 in step S14b and acquires the channel information from the input audio data in step S14c.

Thereafter, the audio division module 32 compares the acquired channel information and the channel selection information stored in the selection information storage module 36g in step S14d and determines the audio data of the channel which can be reproduced in the optical disk reproduction device 11 in step S14e.

The audio division module 32 outputs the audio data of the channel, which has been determined to be capable of being reproduced in the optical disk reproduction device 11 (step S14e is “Yes”), to the audio decoder 30 in step S14f. Meanwhile, the audio division module 32 outputs the audio data of the channel, which has been determined that it cannot be reproduced in the optical disk reproduction device 11 (step S14e is “No”), to the audio reproducing apparatus 18 in step S14g.

After step S14f or S14g, the audio division module 32 determines whether or not the input of the audio signal is terminated in step S14h. When it is determined that the input of the audio signal is not terminated (step S14h is “No”), the processing is returned to step S14b. When it is determined that the input of the audio signal is terminated (step S14h is “Yes”), the processing is terminated (step S14i).

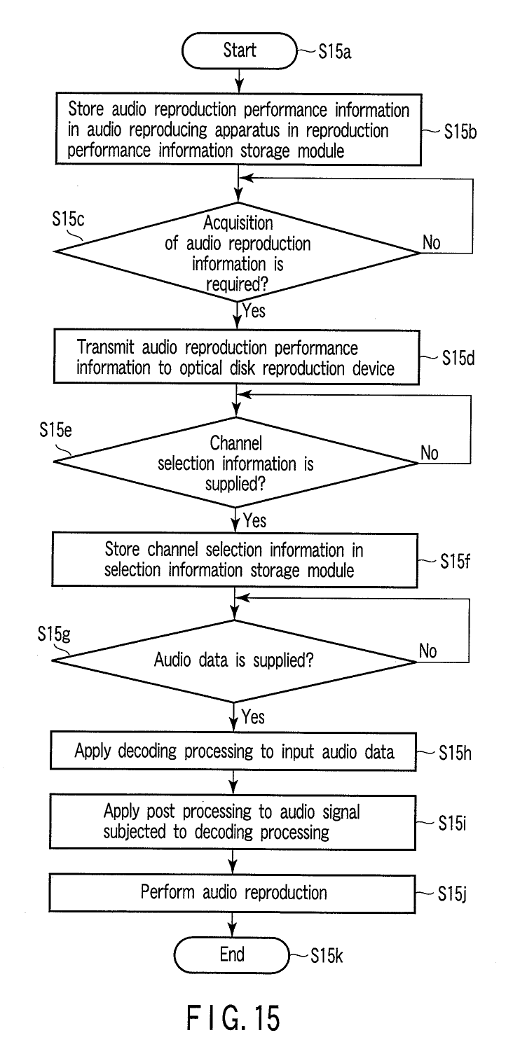

FIG. 15 is a flowchart showing the main processing operation in the audio reproducing apparatus 18 shown in FIG. 11. When the processing is started (step S15a), the audio reproduction performance information in the audio reproducing apparatus 18 is recorded in the reproduction performance information storage module 43c in step S15b. In such a state, the control module 43 determines whether or not the acquisition of the audio reproduction performance information is required by the optical disk reproduction device 11 in step S15c. When the acquisition is required (step S15c is “Yes”), the audio reproduction performance information stored in the reproduction performance information storage module 43c is transmitted to the optical disk reproduction device 11 in step S15d.

Thereafter, the control module 43 determines whether or not the channel selection information is supplied from the optical disk reproduction device 11 in step S15e. When the channel selection information is supplied (step S15e is “Yes”), the input channel selection information is stored in the selection information storage module 43d in step S15f.

Subsequently, the control module 43 determines whether or not the audio data of the channel, which cannot be reproduced in the optical disk reproduction device 11, is supplied from the optical disk reproduction device 11 in step S15g. When step S15g is “Yes”, the input audio data are subjected to a decoding processing by the audio decoder 44 on the basis of the channel selection information in step S15h, and then, the audio signal subjected to the decoding processing is subjected to a post processing by the post-processing module 45 in step S15i.

Thereafter, the control module 43 supplies each audio signal, subjected to the post processing, to the corresponding speakers 19 to 22 through the output terminals 421 to 424, and, thus, to perform the audio reproduction (step S15j), whereby the processing is terminated (step S15k).

In the above example, the reproduction performance determination module 36e of the control module 36 of the optical disk reproduction device 11 determines the audio channels to be respectively reproduced by the speakers 12 to 17 and 19 to 22, on the basis of the audio reproduction performance information in the optical disk reproduction device 11, the audio reproduction performance information in the audio reproducing apparatus 18, and the audio channel information acquired from the optical disk 23, and, thus, to create the channel selection information as shown in FIG. 7.

In this case, if the created channel selection information can be updated by a user, the user can perform the audio reproduction with a higher degree of freedom. For instance, the channel selection information shown in FIG. 7 can be updated so that the audio signal of the front left center channel and the audio signal of the front right center channel are respectively allocated to the front left speaker 12 and the front right speaker 13 of the optical disk reproduction device 11 and the audio signal of the front left channel and the audio signal of the front right channel are respectively allocated to the front left speaker 19 and the front right speaker 20.

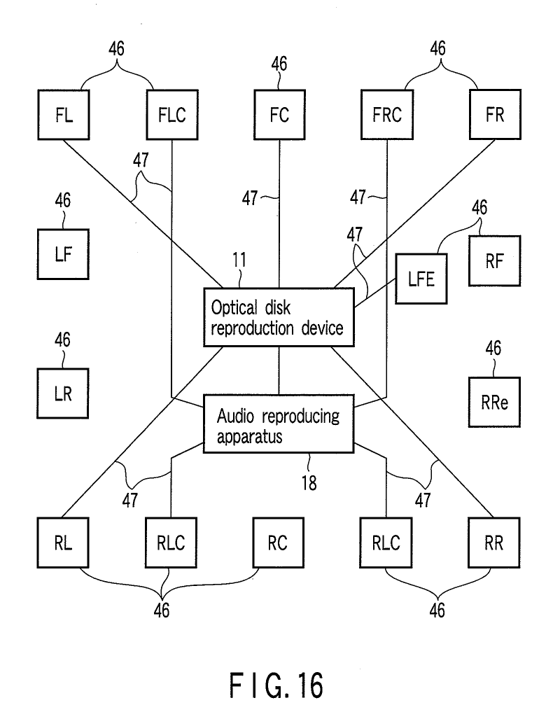

A user operates the remote controller 37 to display an updating menu screen in the video display module 29, whereby the updating of the channel selection information as above-described is performed on the updating menu screen. FIG. 16 shows an example of the updating menu screen. The updating menu screen has a composition in which a plurality of speakers 46 are disposed at a predetermined position around the optical disk reproduction device 11 and the audio reproducing apparatus 18 connected to the optical disk reproduction device 11. The optical disk reproduction device 11, the audio reproducing apparatus 18, and speakers 46 connected thereto are connected to each other through connecting wires 47.

A user operates the remote controller 37 to designate the intended speaker 46 from the speakers connected through the connected wires 47, and, thus, to correspond the audio channel to the designated speaker 46, whereby the user can update the channel selection information.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio reproduction device comprising:
a channel information acquisition module configured to analyze input audio information to determine channel information including a number of reproducible audio channels;
a reproduction performance information acquisition module configured to request, to an external audio reproducing apparatus, external audio reproduction performance information including a number of audio channels capable of being reproduced by the external audio reproducing apparatus, and to receive the external audio reproduction performance information from the external audio reproducing apparatus;
a selection information generation module configured to generate selection information used for dividing the input audio information into a first set of audio channels which can be reproduced by the audio reproduction device itself and a second set of audio channels which cannot be reproduced by the audio reproduction device itself, based on the channel information, the external audio reproduction performance information, and internal audio reproduction performance information of the audio reproduction device; and
a division module configured to extract first audio information of the first set of audio channels from the input audio information based on the selection information, in order to reproduce the first audio information via a speaker connected to the audio reproduction device, and to extract second audio information of the second set of audio channels from the input audio information based on the selection information, in order to output the second audio information to the external audio reproducing apparatus, and, thus, to reproduce the second audio information in the external audio reproducing apparatus.

2. The audio reproduction device of claim 1, wherein the division module is configured to compare the channel information determined by analyzing the input audio information and the selection information generated by the selection information generation module, and to divide the input audio information into the first audio information of the first set of audio channels and the second audio information of the second set of audio channels.

3. The audio reproduction device of claim 1, wherein the selection information comprises the correspondence table between either first or second set of speakers connected to the audio reproduction device or second speakers of the audio reproducing apparatus, and the first or second set of audio channels to be reproduced by the first or second set of speakers respectively.

4. The audio reproduction device of claim 1, wherein the division module is configured to output audio information acquired by decoding the input audio information to the external audio reproducing apparatus.

5. The audio reproduction device of claim 1, wherein the division module is configured to output the input audio information without decoding to the external audio reproducing apparatus.

6. The audio reproduction device of claim 5, wherein the division module is configured to output the selection information generated by the selection information generation module to the external audio reproducing apparatus.

7. A method for audio reproduction, comprising:
analyzing input audio information to determine channel information including a number of reproducible audio channels;
requesting, to an external audio reproducing apparatus, audio reproduction performance information including a number of audio channels which can be reproduced by the external audio reproducing apparatus to receive the external audio reproduction performance information from the external audio reproducing apparatus;
generating selection information used for dividing the input audio information into a first set of audio channels which can be reproduced by an audio reproduction device and a second set of audio channels which cannot be reproduced by the audio reproduction device, based on the determined channel information, the audio reproduction performance information received from the external audio reproducing apparatus, and the audio reproduction performance information of the audio reproduction device; and
separating first audio information of the first set of audio channels from the input audio information, based on the generated selection information to reproduce the first audio information via a speaker connected to the audio reproduction device, and, separating second audio information of the second set of audio channels from the input audio information, based on the selection information to output the second audio information to the external audio reproducing apparatus, and, thus, to reproduce the second audio information in the external audio reproducing apparatus.

8. An audio reproduction system comprising:
a first audio reproduction device comprising
a channel information acquisition module configured to analyze input audio information to determine channel information including a number of reproducible audio channels;
a reproduction performance information acquisition module configured to request to and obtain from an external apparatus external audio reproduction performance information, including a number of reproducible audio channels of the external apparatus;
a selection information generation module configured to generate selection information used for dividing the input audio information into a first set of audio channels which can be reproduced by the first audio reproduction device itself and a second set of audio channels which cannot be reproduced by the first audio reproduction device itself, based on the channel information, the external audio reproduction performance information, and reproduction performance information of the first audio reproduction device itself; and
a division module configured extract first audio information of the first set of audio channels from the input audio information based on the selection information, in order to reproduce the first audio information via a speaker connected to the first audio reproduction device, and, to extract the second audio information of the second set of audio channels from the input audio information based on the selection information in order to output the second audio information to the external apparatus; and
a second audio reproduction device comprising:
a reproduction performance information output module configured to receive the request of the external audio reproduction performance information in the second audio reproduction device itself from the first audio reproduction device and to output the external audio reproduction performance information to the first audio reproduction device; and
a control module configured to receive the second audio information from the first audio reproduction device, and to reproduce the second audio information via a speaker connected to the second audio reproduction device.
